(19) United States
(12) Patent Application Publication
(10) Pub. No.: US 2026/0036258 A1
(43) Pub. Date: Feb. 5, 2026

(54) Ceiling-Mounted Display Device Bracket

(71) Applicants: Ningbo Tuotuo River Design Company, Ningbo (CN); CKnapp Sales, Inc., Goodfield, IL (US)

(72) Inventors: Zhimin Wang, Ningbo (CN); Hanxing Hong, Ningbo (CN); Junmin Jin, Ningbo (CN); Hailei Cai, Ningbo (CN)

(73) Assignees: Ningbo Tuotuo River Design Company, Ningbo (CN); CKnapp Sales, Inc., Goodfield, IL (US)

(21) Appl. No.: 19/285,905

(22) Filed: Jul. 30, 2025

(30) Foreign Application Priority Data
Jul. 30, 2024 (CN) CN202421811058.X
Jul. 17, 2025 (CN) CN202521504499.X

(51) Int. Cl. F16M 13/02; A47B 97/00

(52) U.S. Cl. CPC F16M 13/027; A47B 97/001; F16M 2200/041

(57) ABSTRACT

The present invention provides a ceiling-mounted display device bracket, which belongs to the technical field of display bracket, and includes a top plate configured to mount on a ceiling; a bracket for mounting a display device, the bracket is rotatably connected to the top plate; a force applying member, one end of which is rotatably connected to the top plate, and the other end of which is rotatably connected to the bracket; wherein, the force applying member is configured to provide a biasing force that assists in operation to rotate the bracket relative to the top plate, to achieve unfolding and folding of the bracket. The present invention can easily realize the unfolding, folding and angle change of a TV through the force applying member, and the operation is convenient and reliable.

### FIELD

The present invention relates to the technical field of display brackets, in particular to a ceiling-mounted display device bracket.

### BACKGROUND

At present, the existing ceiling-mounted TV bracket, as shown in FIGS. 1 and 2, includes a mounting plate 300 and a bracket 20 for mounting a TV, and the mounting plate 300 is mounted on the ceiling, wherein the mounting plate 300 and the bracket 20 are rotationally connected to each other through cooperation of screws and nuts. When the TV mounted on the bracket 20 is unfolded, folded or adjusted in angle, the user needs to lift the TV to pull or push it, making the operation relatively inconvenient, and the heavier the TV is, the more difficult it is to operate.

### SUMMARY

The present invention aims at solving the above problems in the prior art by proposing a ceiling-mounted display device bracket which is convenient for TV unfolding, folding and angle adjustment.

The purpose of the present invention can be achieved through the following technical solutions: a ceiling-mounted display device bracket comprising:
a top plate configured to mount on the ceiling;
a bracket for mounting a display device, the bracket is rotatably connected to the top plate;
a force applying member, one end of the force applying member is rotatably connected to the top plate, and the other end of the force applying member is rotatably connected to the bracket, wherein the force applying member is configured to provide a biasing force that assists in operation to rotate the bracket relative to the top plate, to achieve unfolding and folding of the bracket.

In the above ceiling-mounted display device bracket, further comprising: a fixed member fixedly connected to the bracket; and a sliding member rotatably connected to the force applying member, and the sliding member is slidably fitted with the fixed member, wherein the sliding member and the fixed member are provided with a guiding structure and an adjusting structure, so that the fixed member and the sliding member have at least two relative positions. In a first sliding position and a second sliding position, the force applying member is configured to provide forces of different magnitudes to the bracket.

In the above ceiling-mounted display device bracket, the guiding structure includes two guiding channels and two guiding threaded members, the fixed member is provided with an accommodation cavity, and a part of the sliding member is accommodated and slidably fitted within the accommodation cavity; the two guiding channels are respectively arranged at two sides of the accommodation cavity along a sliding direction; the two guiding threaded members are connected to the sliding member after respectively passing through the two guiding channels.

In the above ceiling-mounted display device bracket, the adjusting structure includes an adjusting screw rod, and an axial direction of the adjusting screw rod is consistent with the sliding direction of the sliding member, wherein one end of the adjusting screw rod is an adjusting end, and the sliding member is screwed on the adjusting screw rod, rotation of the adjusting screw rod causes the sliding member to move along the axial direction of the adjusting screw rod.

In the above ceiling-mounted display device bracket, the bracket is provided with an avoidance hole near one end where the bracket is connected to the fixed member, for receiving an adjusting wrench.

In the above ceiling-mounted display device bracket, the force applying member is a gas spring; there are two gas springs, and one end of each of the two gas springs is rotatably connected to the top plate through the first rotating member, and the other ends of the two gas springs are respectively located on two sides of the sliding member and are rotatably connected to the sliding member through a second rotating member.

In the above ceiling-mounted display device bracket, two connecting plates are arranged side by side and vertically on the top plate, one end of the bracket connected to the top plate is clamped between the two connecting plates, and a rotating part is arranged between the connecting plates and the bracket, wherein the rotating part includes:
two first rotating holes respectively arranged on the two connecting plates;
second rotating holes arranged on the bracket and fitted with the first rotating holes;
a third rotating member, sequentially passing through the first rotating holes and the second rotating holes, so as to complete the rotational connection between the top plate and the bracket.

In the above ceiling-mounted display device bracket, two connecting plates are vertically arranged.

In the above ceiling-mounted display device bracket, a limiting part is arranged between the connecting plates and the bracket, wherein the limiting part includes:
two first connecting holes arranged on the two connecting plates;
second connecting holes arranged on the bracket;
a guiding member, sequentially passing through the first connecting holes and the second connecting holes, wherein the first connecting holes or the second connecting holes are arc-shaped to limit a rotation angle of the bracket.

In the above ceiling-mounted display device bracket, a rotational connection position between the top plate and the bracket is a first position, a rotational connection position between the top plate and the fixed end of the force applying member is a second position, and a rotational connection position between the sliding member and the output end of the force applying member is a third position, wherein the first position, the second position and the third position form a triangular structure. When the ceiling-mounted display device bracket is in an unfolded state, the third position is located below a line connecting the first position and the second position; when the ceiling-mounted display device bracket is in a folded state, the third position is located above the line connecting the first position and the second position.

In the above ceiling-mounted display device bracket, a rotating mechanism is further included, which is arranged between the top plate and the bracket; the rotating mechanism has a fixed support and a damping adjusting component; the fixed support is fixedly connected to the top plate, and the damping adjusting component is connected to the bracket; the damping adjusting component is rotatably arranged within a mounting hole of the fixed support, thereby enabling adjustment of a rotational friction force between the damping adjusting component and an inner wall of the mounting hole.

In the above ceiling-mounted display device bracket, the damping adjusting component includes an adjusting body, an adjusting member, and a damping friction member;
the adjusting body is fixedly connected to the bracket;
the damping friction member is arranged between the adjusting body and the inner wall of the mounting hole, with an outer wall of the damping friction member cooperating with the mounting hole and an inner wall of the damping friction member cooperating with an inclined surface or a curved surface of the adjusting body;
the adjusting member is used to adjust the relative movement of the damping friction member with respect to the adjusting body, so as to adjust the friction force between the outer wall of the damping friction member and the inner wall of the mounting hole.

In the above ceiling-mounted display device bracket, the damping adjusting component further includes an adjusting pressing plate;
the adjusting body has an adjusting through-hole;
the adjusting member is inserted into the adjusting through-hole and is rotatably
connected to the adjusting pressing plate;
the adjusting pressing plate abuts against the damping friction member;
the adjusting member is rotated to drive the adjusting pressing plate to move up and down along a rotation axis, adjusting relative up and down positions between the damping friction member and the adjusting body, thereby adjusting a magnitude of the rotational friction force between the damping adjusting component and the inner wall of the mounting hole.

In the above ceiling-mounted display device bracket, an outer peripheral surface of the adjusting body is provided with multiple grooves, and a bottom wall of each groove is inclined; each groove is provided with one damping friction member;
the damping friction member is configured to slide along the groove during the up and down movement of the adjusting pressing plate, so as to adjust the magnitude of the rotational friction force between the outer wall of the damping friction member and the inner wall of the mounting hole.

In the above ceiling-mounted display device bracket, a guiding protrusion is further provided inside the groove, and the guiding protrusion is arranged along an extension direction of the groove;
the damping friction member is further provided with a guide groove adapted to the shape of the guiding protrusion; the damping friction member slides along the groove under the cooperation of the guiding protrusion and the guide groove.

In the above ceiling-mounted display device bracket, the rotating mechanism has a rotating fixed base plate, which is fixedly connected to the bracket and a lower end of the adjusting body respectively.

In the above ceiling-mounted display device bracket, a bottom of the adjusting body is provided with a connecting protrusion;
the rotating fixed base plate is provided with a positioning hole adapted to the connecting protrusion;
the connecting protrusion is inserted into the positioning hole, and an adjusting part of the adjusting member is exposed to the positioning hole.

In the above ceiling-mounted display device bracket, the rotating mechanism has a rotating housing and a rotating bottom support;
the rotating bottom support is fixedly connected to the rotating fixed base plate and is sleeved outside the fixed support;
a first planar bearing is provided between the rotating bottom support and the fixed support;
a second planar bearing is provided between the rotating housing and the fixed support;
the rotating housing covers outside the rotating bottom support, the fixed support, the first planar bearing, and the second planar bearing, and is fixedly connected to the rotating fixed base plate.

In the above ceiling-mounted display device bracket, the rotating mechanism further includes a rotation limit member, which is arranged between the rotating housing and the top plate;
the top plate is provided with a limit protrusion, which is used to limit a rotation angle of the rotation limit member;
the rotation limit member is rotatably connected to the rotating housing, the rotation limit member and the rotating housing is configured to rotate relative to each other by a preset angle, so that the rotating housing is configured to rotate positively and negatively by 180 degrees relative to the top plate.

In the above ceiling-mounted display device bracket, an outer side of the rotating housing is provided with a limit groove;
an outer side of the rotation limit member is provided with a first protruding structure, which is used to abut against the limit protrusion; an inner side of the rotation limit member is provided with a second protruding structure; the second protruding structure is slidably arranged within the limit groove;
when the first protruding structure abuts against the limit protrusion, the second protruding structure is configured to slide along the limiting groove, so that the rotating housing is configured to continue to rotate under an external force, thereby enabling the rotating housing to rotate positively and negatively by 180 degrees relative to the top plate.

Compared with the prior art, the present invention has the following beneficial effects:

The ceiling-mounted display device bracket provided by the present invention can easily realize the unfolding, folding and angle change of the TV through the force applying member, and the operation is convenient and reliable.

The relative position between the fixed member and the sliding member, that is, the relative position between the output end and the fixed end is changed through the guiding structure and the adjusting structure in the force adjusting means, so as to adapt to TVs with different sizes and weights, improving the stability, reliability and safety of the TV mounted on the ceiling-mounted display device bracket.

By providing the avoidance hole, the wrench can form plug-in fit with the adjusting end on the adjusting screw rod through the avoidance hole, which is convenient for the adjustment of the adjusting screw rod. In addition, in order to avoid interference between the adjusting end of the adjusting screw rod and the display device and to improve an appearance of the whole ceiling-mounted display device bracket, the adjusting end of the adjusting screw rod is retracted into the avoidance hole to prevent it from being exposed.

The rotational connection between the top plate and the bracket is realized by the rotating part, and the rotation angle of the bracket around the top plate is controlled by the limiting part to prevent the bracket from exceeding its rotating stroke during unfolding or folding, thereby improving the reliability and safety of product use.

### BRIEF DESCRIPTION OF THE DRAWINGS

In order to more clearly describe the technical solutions of the embodiments of the present invention or the prior art, accompanying drawings that need to be used in the embodiments or the prior art will be briefly described below. Obviously, the accompanying drawings described below are for only some of the embodiments of the present invention. For those skilled in the art, they may also obtain other embodiments based on these accompanying drawings.

FIG. 1 is a structural schematic diagram of a ceiling-mounted TV bracket in the prior art.

FIG. 2 is an exploded view of the ceiling-mounted TV bracket shown in FIG. 1.

FIG. 3 is a structural schematic diagram of a ceiling-mounted display device bracket in an unfolded state according to the present invention.

FIG. 4 is an exploded view of the ceiling-mounted display device bracket shown in FIG. 3.

FIG. 5 is an exploded view of the ceiling-mounted display device bracket shown in FIG. 3 from another perspective.

FIG. 6 is a structural schematic diagram of a sliding member in a ceiling-mounted display device bracket in a second sliding position according to the present invention.

FIG. 7 is a sectional view of the sliding member in the ceiling-mounted display device bracket in the second sliding position shown in FIG. 6 in a folded state.

FIG. 8 is a sectional view of the sliding member in the ceiling-mounted display device bracket in the second sliding position shown in FIG. 6 in an unfolded state.

FIG. 9 is a structural schematic diagram of the sliding member in the ceiling-mounted display device bracket in a first sliding position according to the present invention.

FIG. 10 is a sectional view of the sliding member in the ceiling-mounted display device bracket in the first sliding position shown in FIG. 9 in a folded state.

FIG. 11 is a sectional view of the sliding member in the ceiling-mounted display device bracket in the first sliding position shown in FIG. 9 in an unfolded state.

FIG. 12 is a structural schematic diagram of the ceiling-mounted display device bracket from a first perspective according to another embodiment of the present invention.

FIG. 13 is a front view of FIG. 12.

FIG. 14 is an exploded view of FIG. 12 from a first perspective.

FIG. 15 is an exploded view of FIG. 12 from a second perspective.

FIG. 16 is a partially enlarged schematic view at P in FIG. 13.

FIG. 17 is a structural schematic diagram of a damping adjusting component of the ceiling-mounted display device bracket shown in FIG. 12 in a first state.

FIG. 18 is a top view of FIG. 17.

FIG. 19 is a structural schematic diagram of the damping adjusting component of the ceiling-mounted display device bracket shown in FIG. 12 in a second state.

FIG. 20 is a top view of FIG. 19.

FIG. 21 is an exploded view of the damping adjusting component of the ceiling-mounted display device bracket shown in FIG. 12.

FIG. 22 is an exploded view of a rotating mechanism of the ceiling-mounted display device bracket shown in FIG. 12 from a first perspective.

FIG. 23 is an exploded view of the rotating mechanism of the ceiling-mounted display device bracket shown in FIG. 12 from a second perspective.

FIG. 24 is a structural schematic diagram of a ceiling-mounted display device bracket in an unfolded state according to yet another embodiment of the present invention.

FIG. 25 is a side view of FIG. 24.

FIG. 26 is a front view of FIG. 24.

FIG. 27 is a structural schematic diagram of the ceiling-mounted display device bracket as shown in FIG. 24 in a folded state.

In the figures: 10. top plate; 11. connecting plate; 111. first rotating hole; 112. first connecting hole; 12. limit protrusion; 13. first connecting plate; 14. second connecting plate;
20. bracket; 21. avoidance hole; 22. second rotating hole; 23. second connecting hole; 24. bracket body; 25. first connecting arm; 26. second connecting arm; 27. hollow area;
30. force applying member; 31. fixed end; 32. output end;
40. sliding member;
50. fixed member; 51. accommodation cavity;
60. guiding structure; 61. guiding channel; 62, guiding threaded member;
70. adjusting structure; 71, adjust screw rod; 711, adjusting end;
80. first rotating member; 81, spacer;
90. second rotating member;
100. third rotating member;
200. guiding member;
D1. first position; D2. second position; D3. third position; R1. damping-increased diameter; R2. damping-decreased diameter;
310. reinforcement plate; 320. frame; 321. crossbar; 322. vertical bar; 400. rotating mechanism; 410. fixed support; 411. mounting hole; 412. first cylindrical portion; 413. disc-shaped portion; 414. second cylindrical portion; 415. first accommodating arc groove; 416.sixth connecting hole; 417. third accommodating arc groove;
420. damping adjusting component; 421. adjusting body; 4211. connecting protrusion; 4212. groove; 4213. guiding protrusion; 4214. adjusting through-hole; 4215. limiting post; 4216. fifth connecting hole; 422. adjusting member; 423. damping friction member; 4231. guide groove; 424. adjusting pressing plate; 4241. recessed structure;
430. rotating fixed base plate; 431. positioning hole; 432. positioning post hole;
440. rotating housing; 441. limit groove; 442. second accommodating arc groove; 443. fourth connecting hole; 444 connecting rib;
450. rotating bottom support; 451. avoidance groove; 452. positioning post; 453. fourth accommodating arc groove; 454. third connecting hole; 460. first planar bearing; 470. second planar bearing;
480. rotation limit member; 481. first protruding structure; 482. second protruding structure;

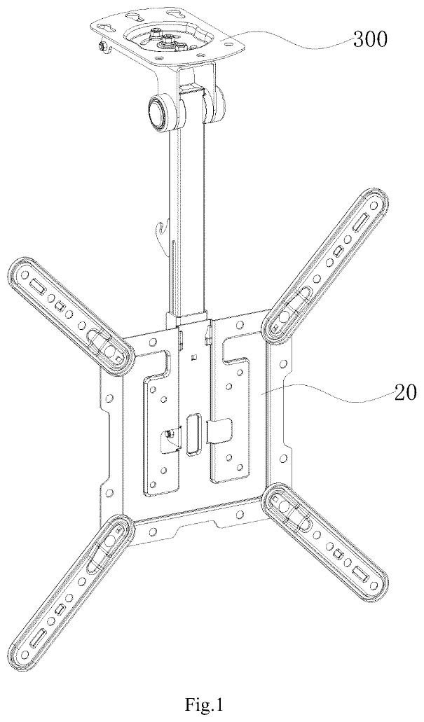

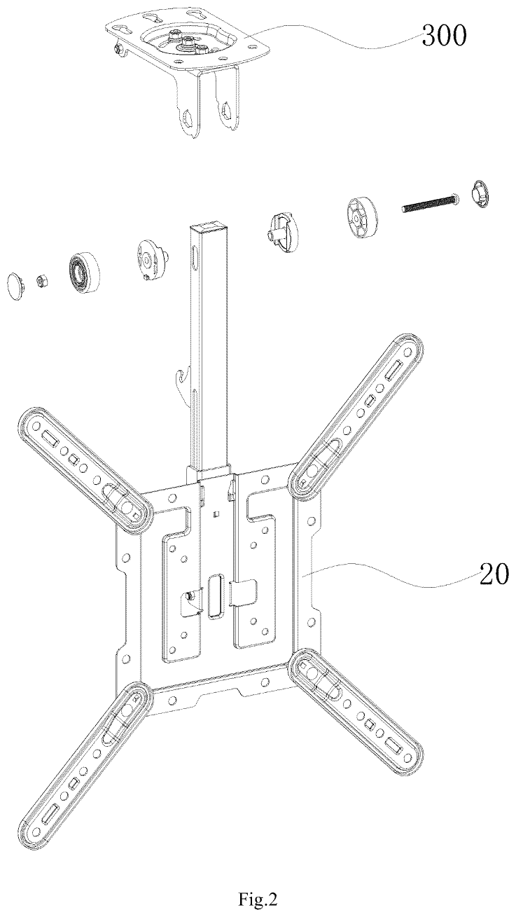

In FIGS. 1 and 2:300. mounting plate.

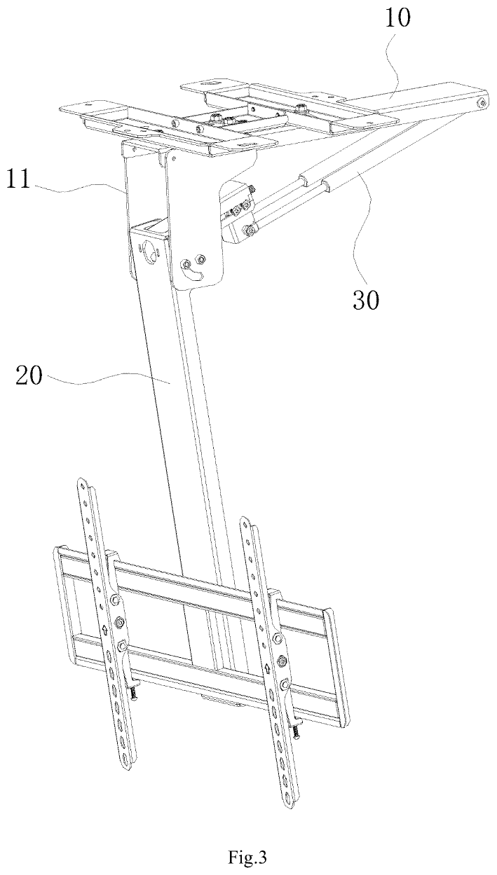

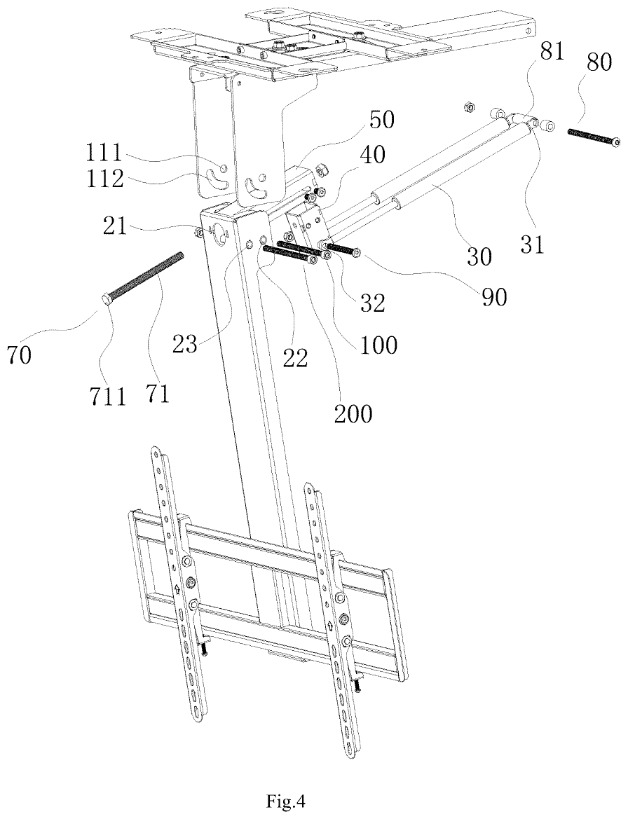

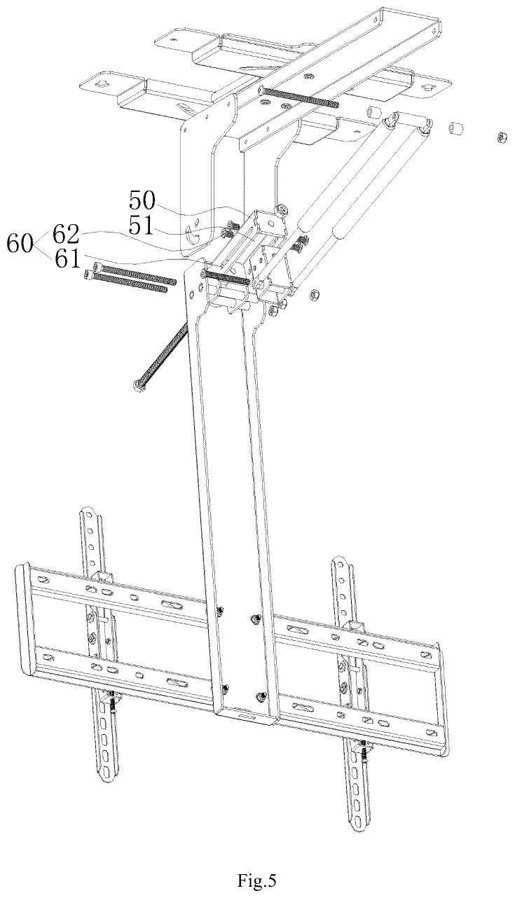

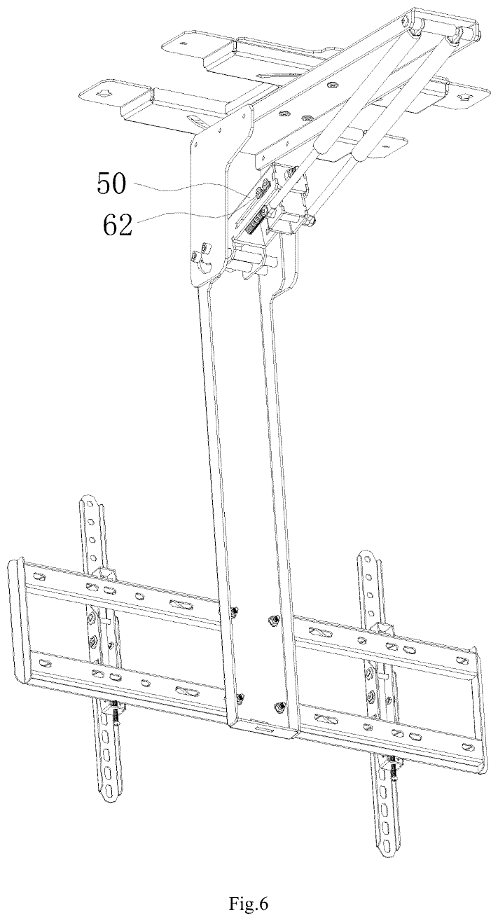

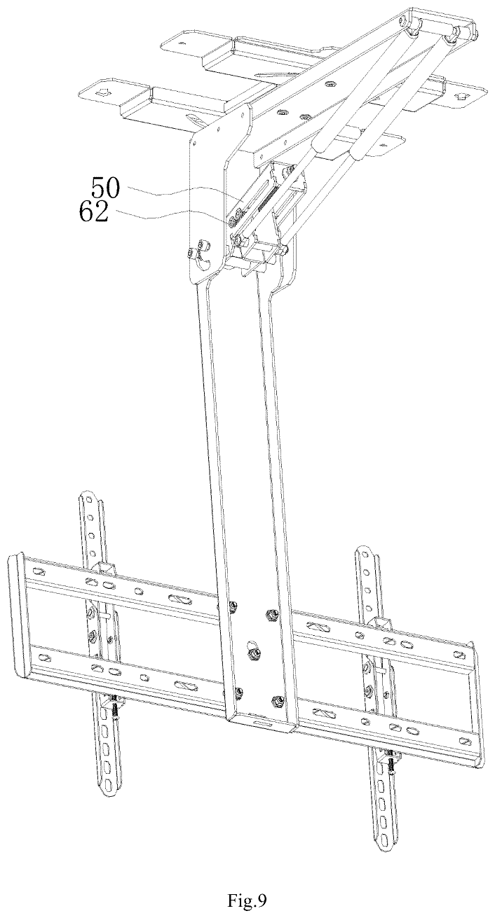

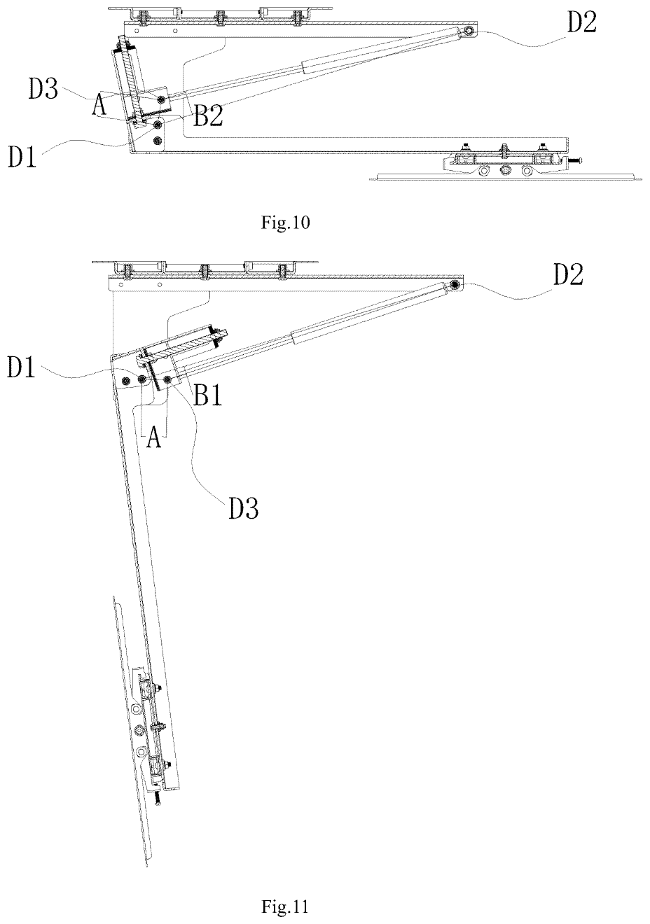

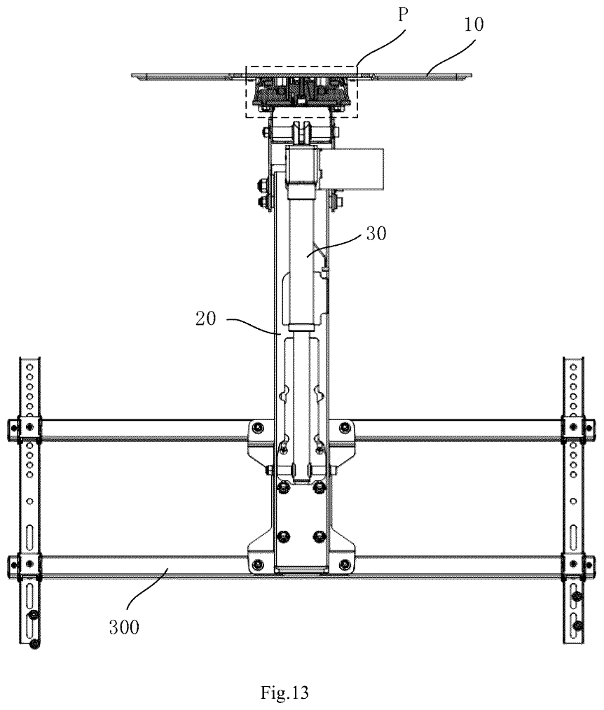

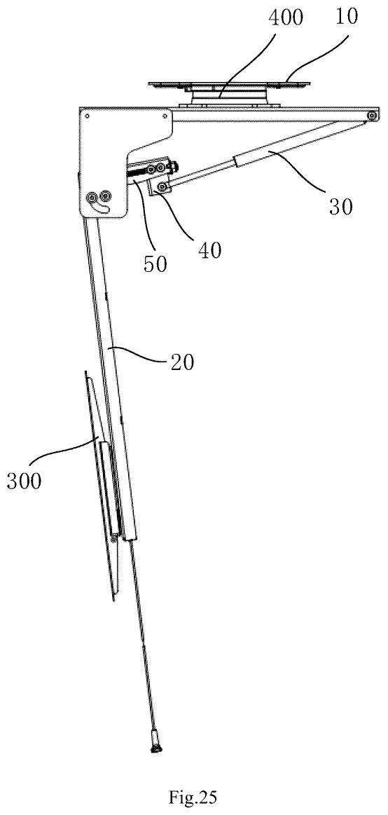

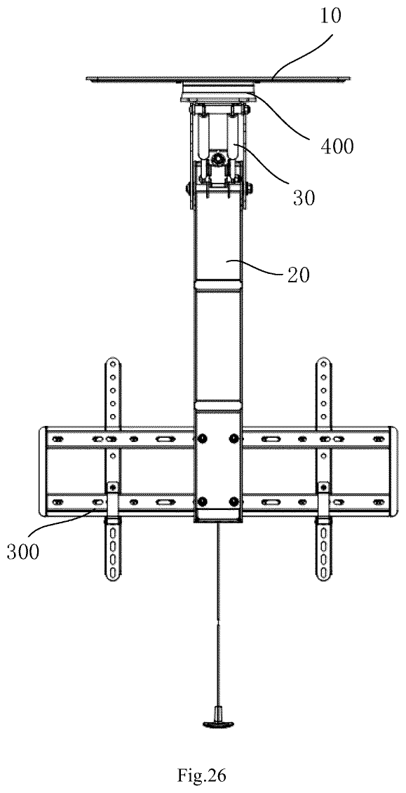

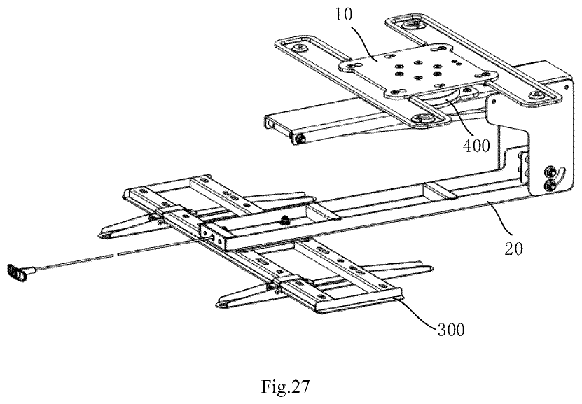

In FIGS. 3 to 27:300. panel.

### DETAILED DESCRIPTION

The following are specific embodiments of the present invention and are described in conjunction with the accompanying drawings. However, the present invention is not limited to these embodiments.

It should be noted that all directional indications (such as up, down, left, right, front, back, etc.) in the embodiments of the invention are only used to explain a relative position relationship and movement situation of components in a certain posture (as shown in the figures), and if a specific posture changes, the directional indication will also change accordingly.

As shown in FIGS. 1 and 2, a ceiling-mounted display device bracket in the prior art includes a mounting plate 300 and a bracket 20 for mounting a TV, and the mounting plate 300 is mounted on the ceiling, wherein the mounting plate 300 and the bracket 20 are rotationally connected to each other through cooperation of screws and nuts. When the TV mounted on the bracket 20 is unfolded, folded or adjusted in angle, the user needs to lift the TV to pull or push it, making the operation relatively inconvenient.

In order to solve the above technical problems, the embodiment of the present invention proposes a ceiling-mounted display device bracket. It should be noted that the display device can be a TV, a computer display, an electronic display board and any other similar display device. In the following, the structure of the ceiling-mounted display device bracket according to embodiments of the present invention will be described in detail with the display device as a TV.

As shown in FIGS. 3 to 11, a ceiling-mounted display device bracket provided by the invention includes:
a top plate 10 mounted on the ceiling;
a bracket 20 for mounting a display device, the bracket 20 is rotatably connected to the top plate 10;
a force applying member 30, one end of which is rotatably connected to the top plate 10, and the other end of which is rotatably connected to the bracket 20;
wherein, under an action of the force applying member 30, the bracket 20 is manually driven to rotate relative to the top plate 10, to achieve unfolding and folding of the bracket 20.

It is worth mentioning that an angle iron structure is roughly formed between the top plate 10 and the bracket 20, and the force applying member 30 is located at a corner of the angle iron structure. One end of the force applying member 30 is rotatably connected to the top plate 10, and the other end of the force applying member 30 is rotatably connected to the bracket 20, so that an included angle between the top plate 10 and the bracket 20 can be changed through the force applying member 30 to realize the unfolding and folding of the bracket 20.

It is further pointed out that when the bracket 20 is folded to its ultimate state, the top plate 10 and the bracket 20 are generally in a parallel state vertically.

The ceiling-mounted display device bracket provided by the present invention can easily realize the unfolding, folding and angle change of the TV through the force applying member 30, and the operation is convenient and reliable.

In this embodiment, the force applying member 30 is preferably, but not limited to, a gas spring, and the two ends of the force applying member 30 are a fixed end 31 and an output end 32, respectively, wherein the fixed end 31 of the force applying member 30 is rotatably connected to the top plate 10, and the output end 32 of the force applying member 30 is rotatably connected to the bracket 20, wherein a relative position between the output end 32 and the fixed end 30 is changed by changing a relative position between a fixed member 50 and a sliding member 40, thereby changing the magnitude of the force that the product can bear.

Preferably, the bracket 20 is provided with a force adjusting means, the force adjusting means includes the fixed member 50 fixedly connected to the bracket 20 and the sliding member 40 rotatably connected to the force applying member 30, and the sliding member 40 is slidably fitted with the fixed member 50; the sliding member 40 and the fixed member 50 are provided with a guiding structure 60 and an adjusting structure 70, so that the fixed member 50 and the sliding member 40 have at least two relative positions. In a first sliding position and a second sliding position, the force applying member 30 can provide forces of different magnitudes to the bracket 20.

It is worth mentioning that in the practical invention process, when users purchase televisions (i.e., TVs), users will choose TVs with different sizes and weights based on the size of indoor space and the user's own requirements for TV size, and such selection will require the ceiling-mounted display device bracket to adapt to motors with different sizes and weights, so as to improve the universality of the whole ceiling-mounted display device bracket and reduce the purchase cost of users.

Therefore, in this embodiment, the relative position between the fixed member 50 and the sliding member 40, that is, the relative position between the output end 32 and the fixed end 31 (including a distance and an angle to the horizontal line) is changed through the guiding structure 60 and the adjusting structure 70 in the force adjusting means, so as to adjust the magnitude of the force that the product can bear, so as to adapt to TVs with different sizes and weights, and improve the stability, reliability and safety of the TV mounted on the ceiling-mounted display device bracket.

In this embodiment, it is further pointed out that generally, the first sliding position and the second sliding position are located at the two ends of the fixed member 50, namely, two extreme positions. According to the figure, the first sliding position can be arranged at a left side of the fixed member 50, and the second sliding position is arranged at a right side of the fixed member 50, wherein when the sliding member 40 is located at the first sliding position, a distance between the output end 32 and the fixed end 31 of the force applying member 30 is the largest, and this is a state where the whole product can bear a force of the smallest value; when the sliding member 40 is located at the second sliding position, the distance between the output end 32 and the fixed end 31 of the force applying member 30 is the smallest, and this is a state where the whole product can bear a force of the largest value.

Therefore, based on the two extreme positions, it is possible to infer the weight range of televisions that the product can accommodate, facilitating users' selection and purchase.

In order to further illustrate the stability of the product in use, a rotational connection position between the top plate 10 and the bracket 20 can be a first position D1, a rotational connection position between the top plate 10 and the fixed end 31 of the force applying member 30 and can be a second position D2, and a rotational connection position between the sliding member 40 and the output end 32 of the force applying member 30 can be a third position D3, wherein the first position D1, the second position D2 and the third position D3 form a triangular structure. When the ceiling-mounted display device bracket is in an unfolded state, the third position D3 is located below a line connecting the first position D1 and the second position D2; when the ceiling-mounted display device bracket is in a folded state, the third position D3 is located above the line connecting the first position D1 and the second position D2.

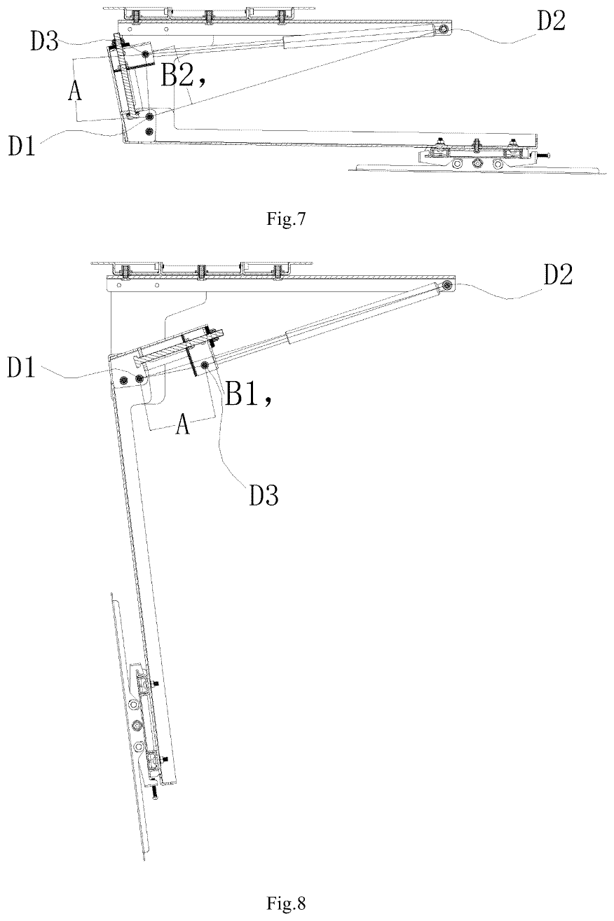

As shown in FIGS. 7 to 11, A represents a distance between the first position D1 and the third position D3. Changing the relative position between the fixed member 50 and the sliding member 40 through the adjusting structure 70 will cause the length of A to change.

When the sliding member 40 is at the second sliding position, the ceiling-mounted display device bracket is in the folded state, and a vertical distance from the third position D3 to the line connecting the first position D1 and the second position D2 is B2;
when the sliding member 40 is at the second sliding position, the ceiling-mounted display device bracket is in the unfolded state, and the vertical distance from the third position D3 to the line connecting the first position D1 and the second position D2 is B1.

When the sliding member 40 is at the first sliding position, the ceiling-mounted display device bracket is in the folded state, and the vertical distance from the third position D3 to the line connecting the first position D1 and the second position D2 is B2;
when the sliding member 40 is at the first sliding position, the ceiling-mounted display device bracket is in the unfolded state, and the vertical distance from the third position D3 to the line connecting the first position D1 and the second position D2 is B1.

B2, >B1, and B2>B1, so that the ceiling-mounted display device bracket in the folded state is more stable.

It is further pointed out that the guiding structure 60 includes two guiding channels 61 and two guiding threaded members 62, the fixed member 50 is provided with an accommodation cavity 51, and a part of the sliding member 40 is accommodated and slidably fitted within the accommodation cavity 51; the two guiding channels 61 are respectively arranged at two sides of the accommodation cavity 51 along a sliding direction; the two guiding threaded members 62 are connected to the sliding member 40 after respectively passing through the two guiding channels 61.

It is worth mentioning that in this embodiment, one end of the guiding threaded member 62 passes through the guiding channel 61 to form a threaded fit with the sliding member 40, and the other end of the guiding threaded member 62 is engaged with the guiding channel 61. When the guiding threaded member 62 is loosened, the sliding member 40 can move from the first position D1 to the second position D2 of the fixed member 50, or from the second position D2 to the first position D1 by virtue of the engagement between the guiding threaded member 62 and the guiding channel 61. After a position of the sliding member 40 on the fixed member 50 is adjusted, the guiding threaded member 62 is tightened again to lock the relative position between the sliding member 40 and the fixed member 50, so that the use of the TV with the current weight is satisfied.

Further preferably, the guiding channel 61 is strip-shaped, and two guiding threaded members 62 are inserted into each guiding channel 61, wherein the two guiding threaded members 62 are arranged side by side and jointly screwed on the sliding member 40.

It is worth mentioning that the interior of the sliding member 40 is hollow, so as to reduce the overall weight of the sliding member 40.

Preferably, the adjusting structure 70 includes an adjusting screw rod 71, and an axial direction of the adjusting screw rod 71 is consistent with the sliding direction of the sliding member 40, wherein one end of the adjusting screw rod 71 is an adjusting end 711, and the sliding member 40 is screwed on the adjusting screw rod 71, rotation of the adjusting screw rod 71 causes the sliding member 40 to move along the axial direction of the adjusting screw rod 71.

It is worth mentioning that the adjusting structure 70 is used in cooperation with the guiding structure 60. When the guiding threaded member 62 is in a loosened state, the adjusting end 711 of the adjusting screw rod 71 is rotated by a tool (such as a wrench), causing the adjusting screw rod 71 to rotate. At this time, a structure similar to a lead screw nut is formed between the adjusting screw rod 71 and the sliding member 40, that is, the rotation of the lead screw can drive the nut to move in an axial direction of the lead screw. Therefore, when the adjusting screw rod 71 rotates, the sliding member 40 can move along the axial direction of the adjusting screw rod 71 and cooperate with the sliding fit between the guiding threaded member 62 and the guiding channel 61, further ensuring the straightness of the sliding member 40 during moving.

On the basis of this embodiment, it is further pointed out that the bracket 20 is provided with an avoidance hole 21 near one end where the bracket 20 is connected to the fixed member 50, for receiving an adjusting wrench.

In this embodiment, by providing the avoidance hole 21, the wrench can form plug-in fit with the adjusting end 711 on the adjusting screw rod 71 through the avoidance hole 21, which is convenient for the adjustment of the adjusting screw rod 71. The reason why the adjusting end 711 of the adjusting screw rod 71 is not exposed outward from the bracket 20 is that a side where the adjusting end 711 of the adjusting screw rod 71 is located is just a side where the display device (such as TV) is mounted on the bracket 20, in order to avoid interference between the adjusting end 711 of the adjusting screw rod 71 and the display device and to improve an appearance of the whole ceiling-mounted display device bracket, the adjusting end 711 of the adjusting screw rod 71 is retracted into the avoidance hole 21 to prevent it from being exposed.

Preferably, there are two force applying members, and the force applying members are gas springs. One end of each of the two gas springs is rotatably connected to the top plate 10 through the first rotating member 80, and the other ends of the two gas springs are respectively located on both sides of the sliding member 40 along its moving direction, and are rotatably connected to the sliding member 40 through a second rotating member 90.

It is worth mentioning that the first rotating member 80 has the same structure as the second rotating member 90, and both of which include a rotating screw rod and a fastening nut. Through a threaded fit between the rotating screw rod and the fastening nut, the rotational connection between the force applying member 30 and the top plate 10, and the rotational connection between the force applying member 30 and the sliding member 40 are realized.

In addition, since there are two force applying members 30, in order to ensure the relative position between the two force applying members 30, one spacer 81 can be arranged between the fixed ends 31 of the two force applying members 30, and both ends of the spacer 81 respectively abut against the fixed ends 31 of the two force applying members 30, so as to ensure that the output ends 32 of the two force applying members 30 are parallel to each other.

Preferably, two connecting plates 11 are arranged side by side and vertically on the top plate 10, wherein the two connecting plates 11 being arranged vertically means that a vertical length of the connecting plates is greater than a transverse length of the same; one end of the bracket 20 connected to the top plate 10 is clamped between the two connecting plates 11, and a rotating part is arranged between the connecting plates 11 and the bracket 20, wherein the rotating part includes:
two first rotating holes 111, respectively arranged on the two connecting plates 11;
second rotating holes 22, arranged on the bracket 20 and fitted with the first rotating holes 111;
a third rotating member 100, sequentially passing through the first rotating holes 111 and the second rotating holes 22, so as to complete the rotational connection between the top plate 10 and the bracket 20.

Preferably, a limiting part is arranged between the connecting plates 11 and the bracket 20, wherein the limiting part includes:
two first connecting holes 112, arranged on the two connecting plates 11;
second connecting holes 23, arranged on the bracket 20;
a guiding member 200, sequentially passing through the first connecting holes 112 and the second connecting holes 23, wherein the first connecting holes 112 or the second connecting holes 23 are arc-shaped to limit the rotation angle of the bracket 20.

In this embodiment, the rotational connection between the top plate 10 and the bracket 20 is realized by the rotating part, and the rotation angle of the bracket 20 around the top plate 10 is controlled by the limiting part to prevent the bracket 20 from exceeding its rotating stroke during unfolding or folding, thereby improving the reliability and safety of product use.

In addition, the structures of the third rotating member 100 and the guiding member 200 in this embodiment are the same as those of the first rotating member 80 and the second rotating member 90, and they are all screw rods, thus the details are not repeated here.

There is currently a ceiling-mounted rotating display device bracket, which includes a top plate, a panel, and a rotating mechanism. This product has the function of manually rotating the display device to adjust left and right angles. For the traditional ceiling-mounted rotating display device bracket that can be manually rotated, the rotation function is achieved through mechanisms such as a rotating shaft or a rotating arc slot with a limiting structure. Due to different sizes of the actual mounted display device, the torque generated on the rotating shaft through rotating the display device varies during actual use, which can lead to significant differences in the perceived hand force required for different sizes of display devices, resulting in defects such as the perceived hand force is too tight or too loose during use. In order to solve the above technical problems, an embodiment of the present invention proposes another ceiling-mounted display device bracket.

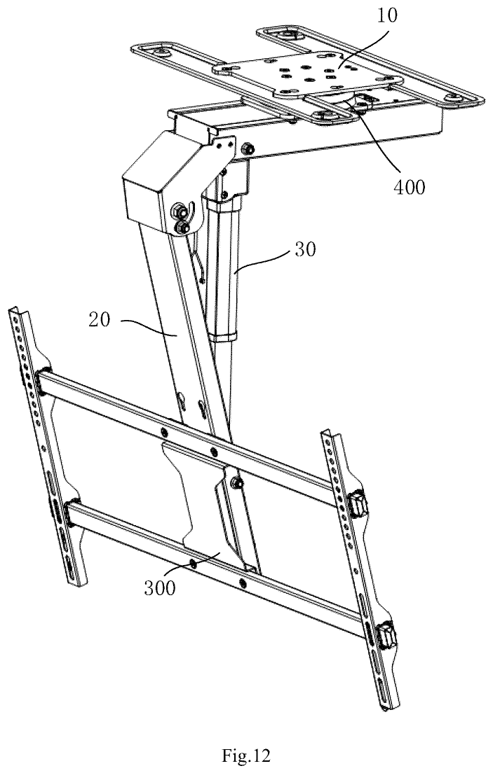

As shown in FIGS. 12 to 23, which are relevant structural diagrams of the ceiling-mounted rotating display device bracket according to another embodiment of the present invention, the ceiling-mounted rotating display device bracket according to embodiments shown in FIGS. 12 to 23 differs from the ceiling-mounted rotating display device bracket according to embodiments shown in FIGS. 1 to 11 in that the structures of the bracket 20 and force applying member 30 are different, and a rotating mechanism 400 is added to the ceiling-mounted rotating display device bracket according to the embodiment shown in FIGS. 12 to 23.

As shown in FIGS. 12 to 23, in this embodiment, the bracket 20 may include a bracket body 24, a first connecting arm 25, and a second connecting arm 26 connected sequentially, wherein the bracket body 24 is connected to the rotating mechanism 400; the second connecting arm 26 is connected to a panel 300; two ends of the first connecting arm 25 are respectively rotatably connected to the bracket body 24 and the second connecting arm 26, and two ends of the force applying member 30 are respectively connected to the bracket body 24 and the second connecting arm 26 to achieve the folding of the bracket 20. Optionally, the force applying member 30 can be an electric push rod.

As shown in FIGS. 12 to 16, the ceiling-mounted rotating display device bracket further includes the rotating mechanism 400, the rotating mechanism 400 is arranged between the top plate 10 and the bracket 20; the rotating mechanism 400 has a fixed support 410 and a damping adjusting component 420; the fixed support 410 is fixedly connected to the top plate 10, and the damping adjusting component 420 is connected to the bracket 20; the damping adjusting component 420 is rotatably arranged within a mounting hole 411 of the fixed support 410, thereby enabling adjustment of the rotational friction force between the damping adjusting component 420 and an inner wall of the mounting hole 411.

In this embodiment, the rotating mechanism 400 is arranged between the top plate 10 and the bracket 20; the rotating mechanism 400 has a fixed support 410 and a damping adjusting component 420; the fixed support 410 is fixedly connected to the top plate 10, and the damping adjusting component 420 is connected to the bracket 20; the damping adjusting component 420 is rotatably arranged within a mounting hole 411 of the fixed support 410, so that the adjustment of the rotational friction force between the damping adjusting component 420 and an inner wall of the mounting hole 411 is achieved, which cause the bracket 20 connected to the damping adjusting component 420 to drive the panel 300 to rotate relative to the top plate 10, enabling manual adjustment of the left and right angles of the display device such as TV. The rotational friction force between the damping adjusting component 420 and the inner wall of the mounting hole 411 can be adjusted, so that the adjustment of the rotational damping is achieved. The rotational damping can be adjusted according to requirements, meaning it can be adjusted for situations where different-sized display devices generate different torques, so that ideal hand force perceived can be achieved when manually adjusting the left and right angles of the different-sized display devices. The ceiling-mounted rotating display device bracket according to the embodiment of the present invention is a damping adjustable manual rotating bracket.

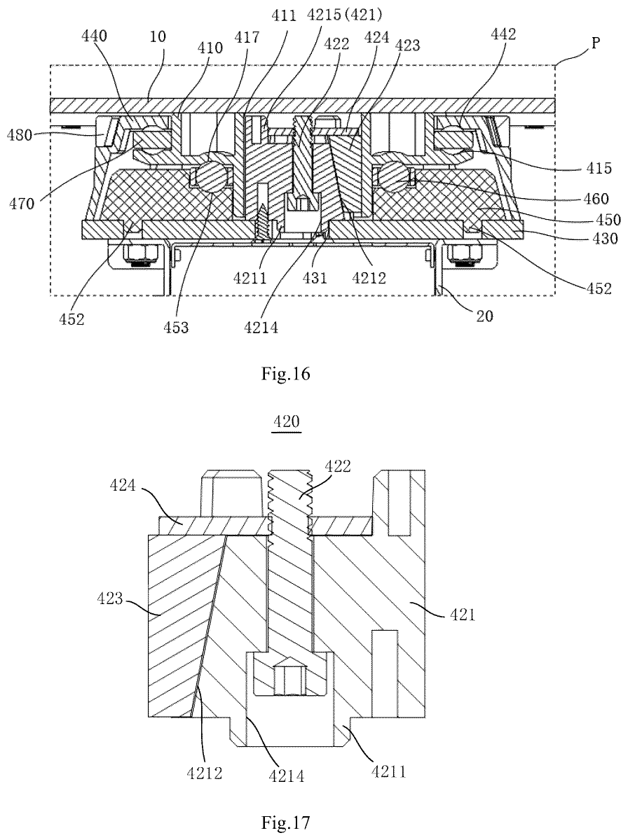

In this embodiment, as shown in FIGS. 16 to 21, the damping adjusting component 420 includes an adjusting body 421, an adjusting member 422, and a damping friction member 423; the adjusting body 421 is fixedly connected to the bracket 20; the damping friction member 423 is arranged between the adjusting body 421 and the inner wall of the mounting hole 411, with an outer wall of the damping friction member 423 cooperating with the mounting hole 411 and an inner wall of the damping friction member 423 cooperating with an inclined surface or a curved surface of the adjusting body 421; the adjusting member 422 is used to adjust the relative movement of the damping friction member 423 with respect to the adjusting body 421, so as to adjust the friction force between the outer wall of the damping friction member 423 and the inner wall of the mounting hole 411. In this embodiment, the inner wall of the damping friction member 423 is fitted with the inclined or curved surface of the adjusting body 421. When the damping friction member 423 is adjusted to move relative to the adjusting body 421, the damping friction member 423 can be expanded or contracted, thereby changing the tightness of the cooperate between the outer wall of the damping friction member 423 and the inner wall of the mounting hole 411, in order to adjust the friction force between the outer wall of the damping friction member 423 and the inner wall of the mounting hole 411.

The adjusting body 421 is fixedly connected to the bracket 20 and can rotate with the bracket 20; the damping friction member 423 is arranged between the adjusting body 421 and the inner wall of the mounting hole 411, with the outer wall of the damping friction member 423 cooperating with the mounting hole 411, and the inner wall of the damping friction member 423 cooperating with the inclined or curved surface of the adjusting body 421, so that the damping friction member 423 can rotate with the adjusting body 421; the rotational friction force between the outer wall of the damping friction member 423 and the inner wall of the mounting hole 411 is the rotational friction force between the damping adjusting component 420 and the inner wall of the mounting hole 411. By adjusting the relative movement of the damping friction member 423 with respect to the adjusting body 421 through the adjusting member 422, the friction force between the outer wall of the damping friction member 423 and the inner wall of the mounting hole 411 can be adjusted. The structure is simple and easy to adjust.

In this embodiment, as shown in FIGS. 16 to 21, the damping adjusting component 420 further includes an adjusting pressing plate 424; the adjusting body 421 has an adjusting through-hole 4214; the adjusting member 422 is inserted into the adjusting through-hole 4214 and is rotatably connected to the adjusting pressing plate 424; the adjusting pressing plate 424 abuts against the damping friction member 423; the adjusting member 422 is rotated to drive the adjusting pressing plate 424 to move up and down along a rotation axis, to adjust relative up and down positions between the damping friction member 423 and the adjusting body 421, thereby to adjust a magnitude of the rotational friction force between the damping adjusting component 420 and the inner wall of the mounting hole 411. It should be noted that the “up and down positions” mentioned in this paragraph and the following refers to the commonly recognized high and low positions when the ceiling-mounted rotating display device bracket is mounted on the ceiling; the “rotation axis” mentioned in this paragraph and the following refers to a rotation axis of the damping adjusting component 420, which is a virtual axis mainly used to illustrate the direction of movement of the adjusting pressing plate 424 and should not be construed as unduly limiting the present invention.

Specifically, one end of the adjusting member 422 has a head for operation; the other end has threads for threaded connection with the adjusting pressing plate 424; the adjusting pressing plate 424 is in anti-rotation fit with the adjusting body 421, and the adjusting pressing plate 424 abuts against the damping friction member 423; the adjusting member 422 is rotated to drive the adjusting pressing plate 424 to move up and down.

During the process of rotating the adjusting member 422, the inner wall of the mounting hole 411 abuts against the damping friction member 423, and the damping friction member 423 pushes the adjusting pressing plate 424 in an axial direction of the rotation axis, so that the adjusting member 422 does not move downward. The inner wall of the mounting hole 411 can be provided with a step structure, the step structure abuts against the head of the adjusting member 422, so that the adjusting member 422 does not move upward, thereby keeping the up and down positions of the adjusting member 422 unchanged; and the adjusting pressing plate 424 is in anti-rotation fit with the adjusting body 421, the adjusting member 422 is rotated to drive the adjusting pressing plate 424 to move up and down along the axial direction of the rotation axis, in order to adjust the relative up and down positions between the damping friction member 423 and the adjusting body 421, and thus adjust magnitude of the rotational friction force between the damping adjusting component 420 and the inner wall of the mounting hole 411.

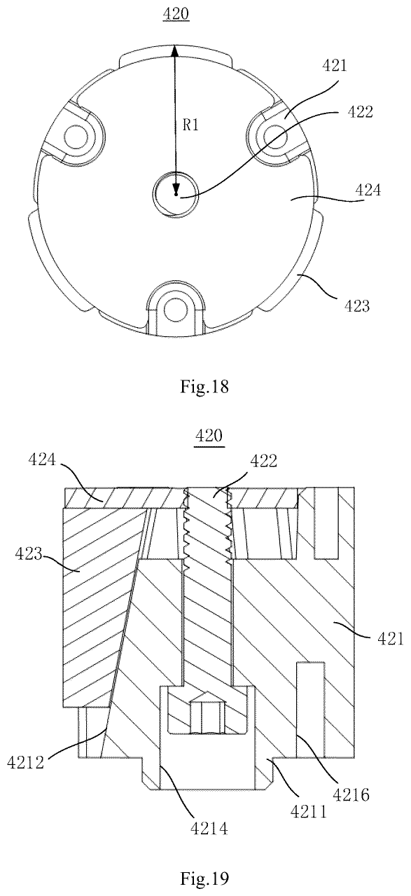

The damping adjusting component 420 shown in FIGS. 17 and 18 is in a first state, where the adjusting pressing plate 424 of the damping adjusting component 420 is in contact with a surface of the adjusting body 421 used to support the adjusting pressing plate 424. At this time, the damping friction member 423 is arranged flush with the adjusting body 421 in the up-down direction, and the damping friction member 423 is expanded to a greater extent. The distance between the outer wall of the damping friction member 423 and the rotation axis is the farthest, which corresponds to a damping-increased diameter R1. The damping friction member 423 applies a greater pushing force on the inner wall of the mounting hole 411, resulting in a larger rotational friction force between the damping friction member 423 and the mounting hole 411.

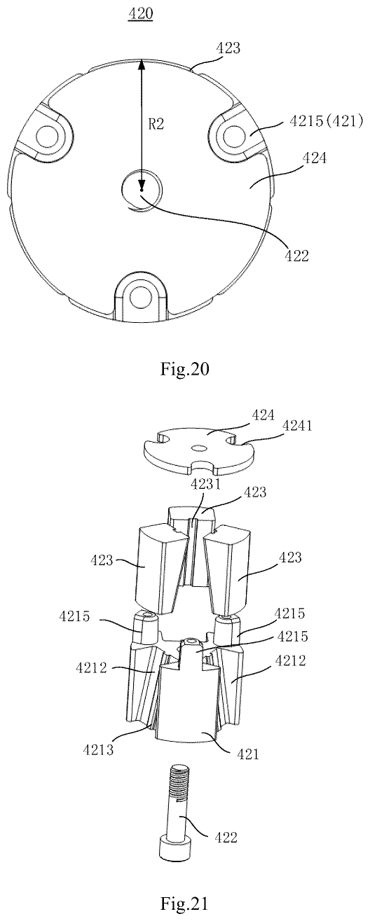

The damping adjusting component 420 shown in FIGS. 19 and 20 is in a second state, where the adjusting pressing plate 424 is spaced apart from the surface of the adjusting body 421 used to support the adjusting pressing plate 424. Compared with the damping adjusting component 420 in the first state, the damping friction member 423 in the second state moves upward relative to the adjusting body 421, the damping friction member 423 is contracted to a greater extent. The distance between the outer wall of the damping friction member 423 and the rotation axis decreases, which corresponds to a damping-decreased diameter R2, R2<R1. The pushing force applied by the damping friction member 423 on the inner wall of the mounting hole 411 is decreased accordingly, resulting in a smaller rotational friction force between the damping friction member 423 and the mounting hole 411.

The damping friction member 423 expands outward during its inclined downward movement, thereby increasing the friction force between the damping friction member 423 and the inner wall of the mounting hole 411 of the fixed support 410. The adjustment of the friction force between the outer wall of the damping friction member 423 and the inner wall of the mounting hole 411 can be achieved by rotating the adjusting member 422, thereby adjusting the rotational friction force between the damping adjusting component 420 and the inner wall of the mounting hole 411, achieving the effect of adjusting the rotational damping.

Optionally, the adjusting member 422 can be a bolt, with a tail end of the adjusting member 422 threaded with the adjusting pressing plate 424 and the head of the adjusting member 422 exposed to the adjusting through-hole 4214. A tool can be inserted into the adjusting through-hole 4214. The adjustment can be achieved by rotating the bolt with the tool.

In this embodiment, as shown in FIGS. 16 to 21, an outer peripheral surface of the adjusting body 421 is provided with multiple grooves 4212, and a bottom wall of each groove 4212 is inclined; each of the grooves 4212 is provided with one damping friction member 423; the damping friction member 423 can slide along the groove 4212 during the up and down movement of the adjusting pressing plate 424, so as to adjust the magnitude of the rotational friction force between the outer wall of the damping friction member 423 and the inner wall of the mounting hole 411. The arrangement of the grooves 4212 allows the damping friction member 423 to be at least partially embedded into the adjusting body 421, which is beneficial for reducing the volume of the damping adjusting component 420; the damping friction member 423 slides along the groove 4212, the groove 4212 has a guiding effect on the sliding of the damping friction member 423, so that the movement of the damping friction member 423 relative to the adjusting body 421 is smoother.

Optionally, as shown in FIGS. 16 to 21, a groove bottom of the groove 4212 can be inclined inward from bottom to top to form a slope, and the inner wall of the damping friction member 423 corresponding to the groove bottom of the groove 4212 is also an inclined surface. A longitudinal section of the damping friction member 423 is wedge-shaped, so that the closer it is to the adjusting pressing plate 424, the deeper the groove 4212 and the thicker the damping friction member 423.

Optionally, as shown in FIG. 20, the outer walls of the damping friction member 423 and the adjusting body 421 are both curved surfaces. When the damping friction member 423 is located at a predetermined position relative to the adjusting body 421, the outer walls of the damping friction member 423 and the adjusting body 421 can coincide with a boundary of the same virtual circle.

In this embodiment, as shown in FIG. 21, a guiding protrusion 4213 is further provided inside the groove 4212, and the guiding protrusion 4213 is arranged along an extension direction of the groove 4212; the damping friction member 423 is further provided with a guide groove 4231 adapted to the shape of the guiding protrusion 4213; the damping friction member 423 slides along the groove 4212 with the cooperation of the guiding protrusion 4213 and the guide groove 4231. The mutual cooperation between the guiding protrusion 4213 and the guiding groove 4231 has a guiding effect on the movement of the damping friction member 423 relative to the adjusting body 421, making the movement of the damping friction member 423 smoother.

In this embodiment, as shown in FIGS. 20 and 21, an edge of the adjusting pressing plate 424 is provided with a recessed structure 4241; one end of the adjusting body 421 near the adjusting pressing plate 424 is provided with a limiting post 4215. The limiting post 4215 is located inside the recessed structure 4241 to prevent the adjusting pressing plate 424 from rotating and achieve an anti-rotation fit between the adjusting pressing plate 424 and the adjusting body 421. Specifically, a positive projection of the limiting column 4215 on the adjusting pressing plate 424 is located between positive projections of two adjacent grooves 4212 on the adjusting pressing plate 424.

Preferably, as shown in FIG. 20, there are three grooves 4212, three damping friction members 423, three limiting posts 4215, and three recessed structures 4241; the three grooves 4212 and the three limiting posts 4215 are evenly distributed.

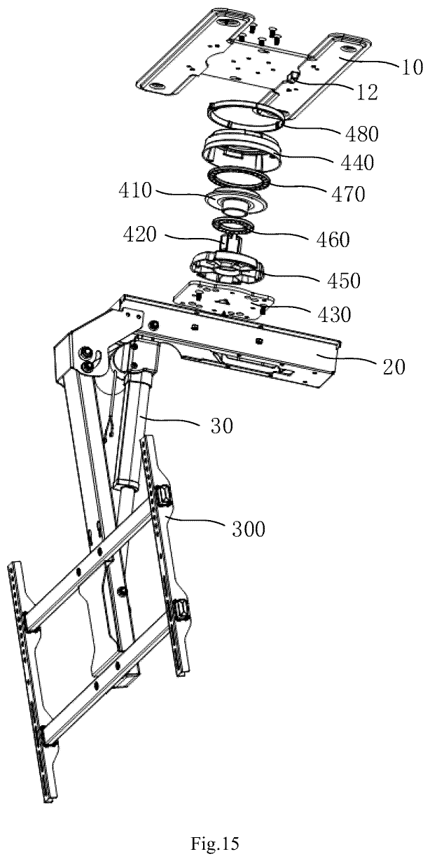

In this embodiment, as shown in FIGS. 15, 19, 22, and 23, the rotating mechanism 400 has a rotating fixed base plate 430, the rotating fixed base plate 430 is fixedly connected to the bracket 20 and a lower end of the adjusting body 421 respectively. The rotating fixed base plate 430 plays a supporting and connecting role, so as to achieve the fixed connection between the adjusting body 421 and the bracket 20.

Specifically, the lower end of the adjusting body 421 may be provided with a fifth connecting hole 4216, and the adjusting body 421 is fixedly connected to the rotating fixed base plate 430 through the fifth connecting hole 4216 and fasteners; the rotating fixed base plate 430 can be fixedly connected to the bracket 20 through the fasteners.

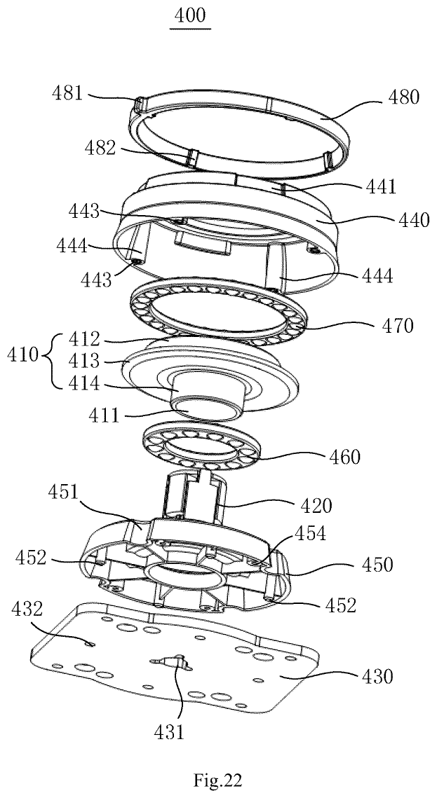

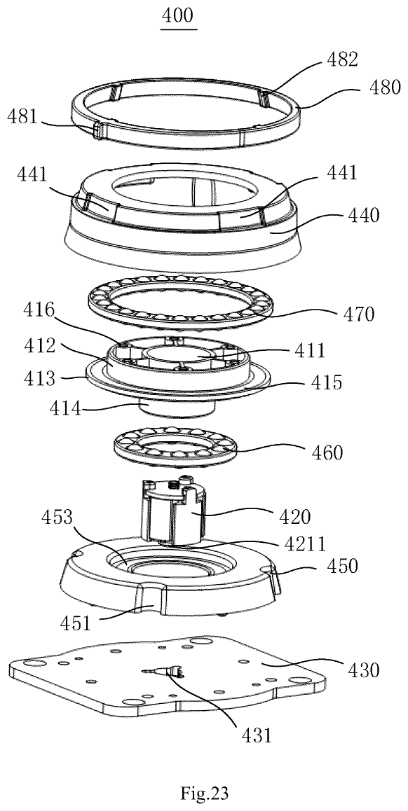

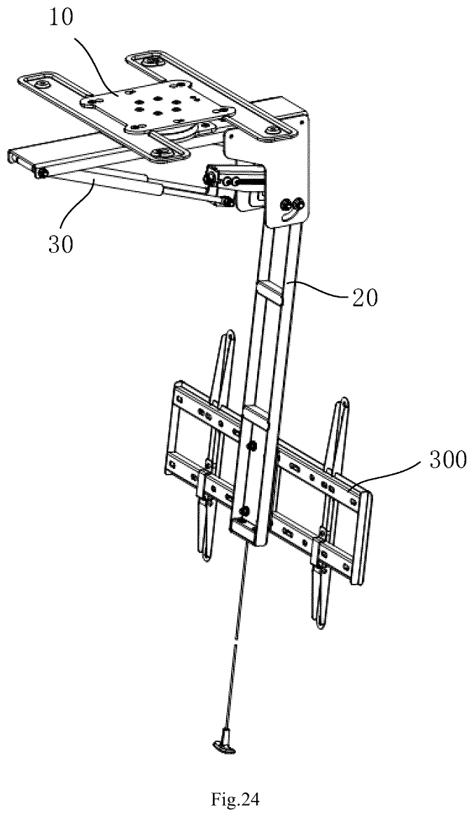

In this embodiment, as shown in FIGS. 22 and 23, a bottom of the adjusting body 421 is provided with a connecting protrusion 4211; the rotating fixed base plate 430 is provided with a positioning hole 431 adapted to the connecting protrusion 4211; the connecting protrusion 4211 is inserted into the positioning hole 431, and an adjusting part of the adjusting member 422 is exposed to the positioning hole 431. The positioning hole 431 plays a positioning role, facilitating the positioning and mounting of the adjusting body 421. Further, the positioning hole 431 also has an avoidance function, which can expose the adjusting part of the adjusting member 422, so that the tool can be inserted into the adjusting through-hole 4214 through the positioning hole 431 to adjust the adjusting member 422, which is convenient for operation.

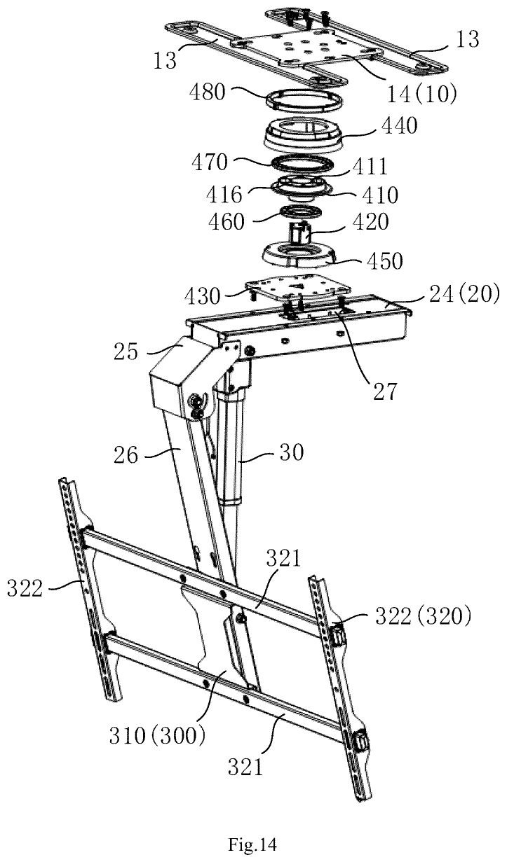

Referring back to FIG. 14, the bracket 20 is provided with a hollow area 27, and the rotating fixed base plate 430 covers the hollow area 27. The hollow area 27 exposes the positioning hole 431, allowing the tool to insert into the adjusting through-hole 4214 through the hollow area 27 and the positioning hole 431 to adjust the adjusting member 422 for ease of adjustment.

Continuing to refer to FIG. 14, the top plate 10 is mounted on the ceiling, and the top plate 10 may include two first connecting plates 13 and one second connecting plate 14; the two first connecting plates 13 are parallel and spaced apart, and the second connecting plate 14 is arranged between the two first connecting plates 13 and connected to the two first connecting plates 13 respectively, wherein the first connecting plates 13 are used to fix to the ceiling, and the second connecting plate 14 is used to fix to the fixed support 410; the fixed support 410 can be provided with multiple sixth connecting holes 416, and the fixed support 410 is fixedly connected to the second connecting plate 14 through the sixth connecting holes 416 and fasteners. There can be six sixth connecting holes 416.

Continuing to refer to FIG. 14, optionally, the ceiling-mounted rotating display device bracket also includes a panel 300, which is mounted on the bracket 20 for mounting the display device. The panel 300 may include a frame 320 and a reinforcement plate 310. The frame 320 includes two parallel crossbars 321 and two parallel vertical bars 322, wherein the crossbars 321 and the vertical bars 322 are vertically arranged to enclose a rectangular space. The reinforcement plate 310 is positioned between the two crossbars 321, and two ends of the reinforcement plate 310 are fixedly connected to the two crossbars 321 respectively. The crossbars 321 and the reinforcement plate 310 are connected to the bracket 20, and the vertical bars 322 are used to connect to the display device.

In this embodiment, as shown in FIGS. 16, 22, and 23, the rotating mechanism 400 has a rotating housing 440 and a rotating bottom support 450; the rotating bottom support 450 is fixedly connected to the rotating fixed base plate 430 and is sleeved outside the fixed support 410; a first planar bearing 460 is provided between the rotating bottom support 450 and the fixed support 410; a second planar bearing 470 is provided between the rotating housing 440 and the fixed support 410; the rotating housing 440 covers outside the rotating bottom support 450, the fixed support 410, the first planar bearing 460, and the second planar bearing 470, and is fixedly connected to the rotating fixed base plate 430.

In this embodiment, the arrangement of the first planar bearing 460 is conducive to reducing the friction between the rotating bottom support 450 and the fixed support 410, and the arrangement of the second planar bearing 470 is conducive to reducing the friction between the rotating housing 440 and the fixed support 410, making the rotation smoother. The rotating housing 440 has a protective effect on its internal structure without affecting the overall appearance.

When manually driving the panel 300 or the bracket 20 to rotate, the rotating fixed base plate 430, the rotating bottom support 450, the damping adjusting component 420, and the rotating housing 440 rotate with the bracket 20. The fixed support 410 is fixedly connected to the top plate 10 and remains stationary. The balls of the first planar bearing 460 and the second planar bearing 470 roll to reduce friction.

Specifically, as shown in FIGS. 16, 22, and 23, the fixed support 410 may include a first cylindrical portion 412, a disc-shaped portion 413, and a second cylindrical portion 414 arranged sequentially from top to bottom, wherein the disc-shaped portion 413 protrudes radially from the first cylindrical portion 412 and the second cylindrical portion 414 of the fixed support 410. The first planar bearing 460 is sleeved outside the second cylindrical portion 414, and the second planar bearing 470 is sleeved outside the first cylindrical portion 412. One side of the disc-shaped portion 413 near the second planar bearing 470 is provided with a first accommodating arc groove 415, and the second planar bearing 470 is arranged inside the first accommodating arc groove 415. Correspondingly, an inner side of the rotating housing 440 is provided with a second accommodating arc groove 442, and the second planar bearing 470 is arranged inside the second accommodating arc groove 442. One side of the disc-shaped portion 413 near the first planar bearing 460 is provided with a third accommodating arc groove 417, and the first planar bearing 460 is arranged inside the third accommodating arc groove 417. One side of the rotating bottom support 450 near the first planar bearing 460 is provided with a fourth accommodating arc groove 453, and the first planar bearing 460 is arranged inside the fourth accommodating arc groove 453.

As shown in FIGS. 16, 22, and 23, the rotating fixed base plate 430 is provided with positioning post holes 432; the rotating bottom support 450 can be provided with positioning posts 452 and third connecting holes 454. A positioning post 452 is inserted into a positioning post hole 432, and the rotating bottom support 450 is fixedly connected to the rotating fixed base plate 430 through the third connecting holes 454 and fasteners.

An inner side of the rotating housing 440 is provided with connecting ribs 444, and the connecting rib 444 is provided with a fourth connecting hole 443. The rotating housing 440 is fixedly connected to the rotating fixed base plate 430 through fourth connecting holes 443. An outer side of the rotating bottom support 450 is provided with avoidance grooves 451 for avoiding the connecting ribs 444 of the rotating housing 440, so that the connecting ribs 444 are embedded in the rotating bottom support 450, thereby facilitating the reduction of the diameter of the rotating housing 440.

In this embodiment, as shown in FIGS. 15 and 16, the rotating mechanism 400 further includes a rotation limit member 480, the rotation limit member 480 is arranged between the rotating housing 440 and the top plate 10; the top plate 10 is provided with a limit protrusion 12, which is used to limit the rotation angle of the rotation limit member 480; the rotation limit member 480 is rotatably connected to the rotating housing 440, and the rotation limit member 480 and the rotating housing 440 can rotate relative to each other by a preset angle, so that the rotating housing 440 can rotate positively and negatively by 180 degrees relative to the top plate 10, so that the adjustable angle of the display device is 360 degrees, which can be applied to more invention scenarios.

In this embodiment, as shown in FIGS. 15, 22, and 23, an outer side of the rotating housing 440 is provided with a limit groove 441; an outer side of the rotation limit member 480 is provided with a first protruding structure 481, the first protruding structure 481 is used to abut against the limit protrusion 12; an inner side of the rotation limit member 480 is provided with a second protruding structure 482; the second protruding structure 482 is slidably arranged within the limit groove 441; when the first protruding structure 481 abuts against the limit protrusion 12, the second protruding structure 482 can slide along the limiting groove 441, so that the rotating housing 440 can continue to rotate under an external force, thereby enabling the rotating housing 440 rotate positively and negatively by 180 degrees relative to the top plate 10.

During the rotation of the rotating housing 440 with the bracket 20, taking the clockwise (positive) direction as an example, the limiting groove 441 will slide relative to the second protruding structure 482. When the second protruding structure 482 slides to abut against the first end of the limiting groove 441, the rotating limiting member 480 will rotate clockwise together with the rotating housing 440; when the first protruding structure 481 of the rotation limit member 480 abuts against the first end of the limit protrusion 12 of the top plate 10, the rotation limit member 480 cannot continue to rotate clockwise; at this time, the second protruding structure 482 can slide relative to the limiting groove 441. The second protruding structure 482 slides from the first end to the second end of the limiting groove 441, allowing the rotating housing 440 to continue rotating clockwise until the second protruding structure 482 abuts against the second end of the limiting groove 441. This avoids the problem of the rotating housing 440 being unable to rotate 180 degrees due to the presence of the limit protrusion 12, which occupies a certain space; the principle of counterclockwise (negative) direction is the same as that of clockwise direction, which will not be repeated here.

Optionally, the rotation limit member 480 can be ring-shaped, sleeved outside the rotating housing 440; the fasteners can be screws.

As shown in FIGS. 24 to 27, which are relevant structural diagrams of the ceiling-mounted rotating display device bracket according to yet another embodiment of the present invention. The ceiling-mounted rotating display device bracket according to the embodiment shown in FIGS. 24 to 27 adds a rotating mechanism 400 on the basis of the ceiling-mounted rotating display device bracket according to the embodiments shown in FIGS. 1 to 11. The specific structure of the rotating mechanism 400 is the same as that of the rotating mechanism 400 in the ceiling-mounted rotating display device bracket according to the embodiments shown in FIGS. 12 to 23. The bracket 20 can be fixedly connected to the rotating fixed base plate 430 of the rotating mechanism 400 through fasteners.

It should be noted that in the present invention, terms such as “first”, “second” and “one” are only used for description, and cannot be understood as indicating or implying their relative importance or implicitly indicating the number of indicated technical features. Therefore, the features defined as “first” and “second” can explicitly or implicitly include at least one of these features. In the description of the present invention, the meaning of “multiple” is at least two (such as two, three, etc.), unless otherwise specifically defined. The terms “connected” and “fixed” should be understood broadly. For example, “fixed” can be a fixed connection, a detachable connection, or integrated; it can be a mechanical connection or an electrical connection; it can be directly connected or indirectly connected through an intermediary, and it can be the internal connection of two elements or the interaction between two elements, unless otherwise specified. For ordinary skilled in the art, the specific meanings of the above terms in the present invention can be understood according to specific conditions.

In addition, the technical solutions of various embodiments of the present invention can be combined with each other, but they must be based on the realization of ordinary skilled in the art. When the combination of the technical solutions is contradictory or impossible, it should be considered that the combination of the technical solutions does not exist and is not within the scope of protection required by the present invention.

The specific embodiment described herein is only an illustration of the spirit of the present invention. Those skilled in the art to which the present invention belongs can make various modifications or supplements to the described specific embodiments or adopt similar methods to replace them, but they will not deviate from the spirit of the present invention or go beyond the scope defined in the appended claims.

1. A ceiling-mounted display device bracket, comprising:
a top plate configured to mount on a ceiling;
a bracket for mounting a display device, the bracket being rotatably connected to the top plate;
a force applying member, one end of the force applying member being rotatably connected to the top plate, and the other end of the force applying member being rotatably connected to the bracket, wherein the force applying member is configured to provide a biasing force that assists in operation to rotate the bracket relative to the top plate, to achieve unfolding and folding of the bracket.

2. The ceiling-mounted display device bracket according to claim 1, further comprising:
a fixed member fixedly connected to the bracket; and
a sliding member rotatably connected to the force applying member, and the sliding member is slidably fitted with the fixed member,
wherein the sliding member and the fixed member are provided with a guiding structure and an adjusting structure, so that the fixed member and the sliding member have at least two relative positions, and in a first sliding position and a second sliding position, the force applying member is configured to provide forces of different magnitudes to the bracket.

3. The ceiling-mounted display device bracket according to claim 2, wherein the guiding structure comprises two guiding channels and two guiding threaded members, the fixed member is provided with an accommodation cavity, and a part of the sliding member is accommodated and slidably fitted within the accommodation cavity; the two guiding channels are respectively arranged at two sides of the accommodation cavity along a sliding direction; the two guiding threaded members are connected to the sliding member after respectively passing through the two guiding channels.

4. The ceiling-mounted display device bracket according to claim 2, wherein the adjusting structure comprises an adjusting screw rod, and an axial direction of the adjusting screw rod is consistent with a sliding direction of the sliding member, wherein one end of the adjusting screw rod is an adjusting end, and the sliding member is screwed on the adjusting screw rod, rotation of the adjusting screw rod causes the sliding member to move along the axial direction of the adjusting screw rod.

5. The ceiling-mounted display device bracket according to claim 4, wherein the bracket is provided with an avoidance hole near one end where the bracket is connected to the fixed member, for receiving an adjusting wrench.

6. The ceiling-mounted display device bracket according to claim 3, wherein the force applying member is a gas spring; there are two gas springs, and one end of each of the two gas springs is rotatably connected to the top plate through a first rotating member, and the other ends of the two gas springs are respectively located on two sides of the sliding member and are rotatably connected to the sliding member through a second rotating member.

7. The ceiling-mounted display device bracket according to claim 1, wherein two connecting plates are arranged side by side and vertically on the top plate, one end of the bracket connected to the top plate is clamped between the two connecting plates, and a rotating part is arranged between the connecting plates and the bracket, wherein the rotating part comprises:
two first rotating holes, respectively arranged on the two connecting plates;
second rotating holes, arranged on the bracket and fitted with the first rotating holes;
a third rotating member, sequentially passing through the first rotating holes and the second rotating holes, so as to complete the rotational connection between the top plate and the bracket.

8. The ceiling-mounted display device bracket according to claim 7, wherein a limiting part is arranged between the connecting plates and the bracket, wherein the limiting part comprises:
two first connecting holes, arranged on the two connecting plates;
second connecting holes, arranged on the bracket;
a guiding member, sequentially passing through the first connecting holes and the second connecting holes, wherein the first connecting holes or the second connecting holes are arc-shaped to limit a rotation angle of the bracket.

9. The ceiling-mounted display device bracket according to claim 2, wherein a rotational connection position between the top plate and the bracket is a first position, a rotational connection position between the top plate and a fixed end of the force applying member is a second position, and a rotational connection position between the sliding member and an output end of the force applying member is a third position, wherein the first position, the second position, and the third position form a triangular structure.

10. The ceiling-mounted display device bracket according to claim 9, wherein when the ceiling-mounted display device bracket is in an unfolded state, the third position is located below a line connecting the first position and the second position; when the ceiling-mounted display device bracket is in a folded state, the third position is located above the line connecting the first position and the second position.

11. The ceiling-mounted display device bracket according to claim 1, wherein it further comprises a rotating mechanism arranged between the top plate and the bracket; the rotating mechanism has a fixed support and a damping adjusting component; the fixed support is fixedly connected to the top plate, and the damping adjusting component is connected to the bracket; the damping adjusting component is rotatably arranged within a mounting hole of the fixed support, thereby enabling adjustment of a rotational friction force between the damping adjusting component and an inner wall of the mounting hole.

12. The ceiling-mounted display device bracket according to claim 11, wherein,
the damping adjusting component comprises an adjusting body, an adjusting member, and a damping friction member;
the adjusting body is fixedly connected to the bracket;
the damping friction member is arranged between the adjusting body and the inner wall of the mounting hole, with an outer wall of the damping friction member cooperating with the mounting hole, and an inner wall of the damping friction member cooperating with an inclined surface or a curved surface of the adjusting body;
the adjusting member is used to adjust relative movement of the damping friction member with respect to the adjusting body, so as to adjust a friction force between the outer wall of the damping friction member and the inner wall of the mounting hole.

13. The ceiling-mounted display device bracket according to claim 12, wherein,
the damping adjusting component further comprises an adjustment pressing plate;
the adjusting body has an adjusting through-hole;
the adjusting member is inserted into the adjusting through hole and is rotatably connected to the adjusting pressing plate;
the adjusting pressing plate abuts against the damping friction member;
the adjusting member is rotated to drive the adjusting pressing plate to move up and down along a rotation axis, adjusting relative up and down positions between the damping friction member and the adjusting body, thereby adjusting a magnitude of the rotational friction force between the damping adjusting component and the inner wall of the mounting hole.

14. The ceiling-mounted display device bracket according to claim 13, wherein,
an outer peripheral surface of the adjusting body is provided with multiple grooves, and a bottom wall of each groove is inclined; each groove is provided with one damping friction member;
the damping friction member is configured to slide along the groove during the up and down movement of the adjusting pressing plate, so as to adjust a magnitude of a rotational friction force between the outer wall of the damping friction member and the inner wall of the mounting hole.

15. The ceiling-mounted display device bracket according to claim 14, wherein a guiding protrusion is further provided inside the groove, and the guiding protrusion is arranged along an extension direction of the groove;
the damping friction member is further provided with a guide groove adapted to the shape of the guiding protrusion; the damping friction member slides along the groove under the cooperation of the guiding protrusion and the guide groove.

16. The ceiling-mounted display device bracket according to claim 12, wherein,
the rotating mechanism has a rotating fixed base plate, the rotating fixed base plate is fixedly connected to the bracket and a lower end of the adjusting body respectively.

17. The ceiling-mounted display device bracket according to claim 16, wherein,
a bottom of the adjusting body is provided with a connecting protrusion;
the rotating fixed base plate is provided with a positioning hole adapted to the connecting protrusion;
the connecting protrusion is inserted into the positioning hole, and an adjusting part of the adjusting member is exposed to the positioning hole.

18. The ceiling-mounted display device bracket according to claim 16, wherein,
the rotating mechanism has a rotating housing and a rotating bottom support;
the rotating bottom support is fixedly connected to the rotating fixed base plate and is sleeved outside the fixed support;
a first planar bearing is provided between the rotating bottom support and the fixed support;
a second planar bearing is provided between the rotating housing and the fixed support;
the rotating housing covers outside the rotating bottom support, the fixed support, the first planar bearing and the second planar bearing, and is fixedly connected to the rotating fixed base plate.

19. The ceiling-mounted display device bracket according to claim 18, wherein,
the rotating mechanism further comprises a rotation limit member, the rotation limit member is arranged between the rotating housing and the top plate;
the top plate is provided with a limit protrusion, the limit protrusion is used to limit a rotation angle of the rotation limit member;
the rotation limit member is rotatably connected to the rotating housing, the rotation limit member and the rotating housing is configured to rotate relative to each other by a preset angle, so that the rotating housing is configured to rotate positively and negatively by 180 degrees relative to the top plate.

20. The ceiling-mounted display device bracket according to claim 19, wherein,
an outer side of the rotating housing is provided with a limit groove;
an outer side of the rotation limit member is provided with a first protruding structure, the first protruding structure is used to abut against the limit protrusion; an inner side of the rotation limit member is provided with a second protruding structure; the second protruding structure is slidably arranged within the limit groove;
when the first protruding structure abuts against the limit protrusion, the second protruding structure is configured to slide along the limiting groove, so that the rotating housing is configured to continue to rotate under an external force, thereby enabling the rotating housing to rotate positively and negatively by 180 degrees relative to the top plate.
